(19) United States
(12) Patent Application Publication
(10) Pub. No.: US 2013/0100781 A1
(43) Pub. Date: Apr. 25, 2013

(54) CHRONOGRAPH MECHANISM, CLOCKWORK MOVEMENT AND TIMEPIECE COMPRISING SUCH A MECHANISM

(71) Applicant: François-Régis Richard, Neuchatel (CH)

(72) Inventor: François-Régis Richard, Neuchatel (CH)

(21) Appl. No.: 13/643,020

(22) PCT Filed: Apr. 22, 2011
(86) PCT No.: PCT/EP2011/056488

§ 371 Date: Jan. 2, 2013

(30) Foreign Application Priority Data
Apr. 23, 2010 (CH) 00597/10
Oct. 11, 2010 (CH) 01665/10

(51) Int. Cl. G04F 7/08

(52) U.S. Cl. CPC G04F 7/0866
USPC 368/106; 368/101

(57) ABSTRACT

A chronograph mechanism for a clockwork movement is disclosed, which is intended to drive at least one first display member for displaying a time unit of a chronometered time. In accordance with one implementation, the chronograph mechanism includes a first counter associated with the display member and able to be driven from a first mobile of the clockwork movement, as well as a second mobile intended to carry the display member and arranged in such a way as to be able to be driven in synchronism with the first counter. The mechanism also includes a second counter of the same time unit associated with the display member and able to be driven in synchronism with the first counter, the second counter being arranged in such a way that the second mobile is driven thereby, while being able to exhibit a relative movement in relation thereto.

### TECHNICAL FIELD

This application is a U.S. Nation Stage application of prior International Application No. PCT/EP2011/056488, filed Apr. 22, 2011 and claiming priority to Swiss (CH) Patent Application No. 00597/10, filed Apr. 23, 2010 and to Swiss (CH) Patent Application No. 01665/10, filed Oct. 11, 2010.

The present invention concerns a chronograph mechanism for a clockwork movement intended to drive at least one first member for displaying a time unit of a chronometered time, the mechanism including a first counter of this time unit able to be driven from a first mobile of the clockwork movement, as well as a second mobile intended to carry the display member and arranged in such a way as to be able to be driven in synchronism with the first counter.

In a preferred embodiment, the first counter may be associated with an additional display member.

In the present text the expression driving in synchronism means that the driving and driven members concerned turn with the same angular speed.

### BACKGROUND

So-called “split-second” chronograph mechanisms have all of the features listed above in relation to the display of the seconds of a chronometered time. To be more precise, a shaft carrying the seconds hand of the chronograph also carries a heart shaped cam, generally situated on the bridges side of the clockwork movement and intended to cooperate with a free end of a lever rotatably mounted on a split-time wheel. The free end of the lever is held continuously in bearing engagement against the periphery of the heart cam so that the chronograph and split-second hands are superposed when the split-time wheel is free to turn. Moreover, the split-second mechanism generally includes a clamp mobile between open and closed positions, the split-second wheel being held in an immobile manner by the clamp in the closed position in order to display an intermediate time and being driven in synchronism with the chronograph counter with the clamp in the open position.

These split-time mechanisms have been known for a long time and have been subject to very few developments in recent years.

U.S. Pat. No. 6,842,403, granted in the name of Lange Uhren GmbH on 11 Jan. 2005, for example, describes a mechanism enabling simultaneous fly-back of two hands, one being the seconds hand of the chronograph and the other being a split-second hand. This document also provides for the use of this mechanism in relation with a clockwork movement further including a split-minute hand of the chronometered minutes,

More recently, patent application EP 2133760 A2 in the name of Manufacture La Joux-Perret SA published on 16 Dec. 2009 describes the use of an additional split-second hand in a clockwork movement including a chronograph mechanism already provided with a first split-second hand.

Swiss patent CH 326792 in the name of the Ancienne manufacture d'horlogerie Patek, Philippe & Co, granted 28 November 1902, describes a double chronograph mechanism. This mechanism includes a first seconds counter driven from a mobile of a clockwork movement and carrying a first hand for indicating chronometered seconds on a hollow first shaft. A second shaft carrying a second hand for indicating chronometered seconds is housed in the hollow first shaft. The second shaft is part of a mobile arranged so as to be able to be driven in synchronism with the first counter of chronometered seconds. To this end, the mobile may be moved axially to be driven or not by the first counter. Thanks to this mechanism, it is possible to measure a second event when the measurement of a first event is already in progress. The second hand may be stopped while the first hand continues to move, then reset to zero and then possibly restarted to effect the measurement of a new event.

### SUMMARY

A principal object of the present invention is to propose a chronograph mechanism enabling a display member to be commanded with a behavior different from that offered by the known mechanisms.

To this end, the subject matter of the present invention is a chronograph mechanism of the type referred to above, further including a second counter of the time unit associated with the first display member and able to be driven in synchronism with the first counter, the second counter being arranged in such a way that the second mobile may be driven thereby, whilst being able to exhibit a relative movement in relation thereto, i.e. to be decoupled therefrom.

There may advantageously be provision for the first counter to be a seconds counter, the mechanism further including members arranged so as to command the starting, stopping and resetting-to-zero of the first counter in response to predefined actions of a user.

Thanks to these features, a chronograph mechanism is obtained that may be capable of driving a display member in the conventional manner in order to display measured times, but that may equally, at the choice of the user, drive that display member in an undisclosed manner. In particular, by way of nonlimiting example, it may be possible thanks to the mechanism of the invention to operate on the second counter and the second mobile associated with the display member so that the latter displays lap times during a race comprising a plurality of laps. It may be possible to operate on the second mobile to stop it at the end of a lap, with the aim of reading off the elapsed lap time, while the second counter is reset to zero and then immediately released to start the measurement of the duration of the next lap. The second mobile can then be released at any time to enable the display member to catch up with the duration counted by the second counter and display the time of the next lap being measured.

An additional object of the present invention is to widen the field of possible applications with reference to those already known in the prior art, namely the split-second function, in relation with chronograph mechanisms including two members for displaying the same unit of a chronometered time.

In this case, the first counter may be associated with an additional display member. It will be noted that, in the particular case where the unit of time is the second, the additional display member may be in fact the seconds display member of the chronograph behaving conventionally, while the first display member may be that exhibiting the new behavior according to the invention.

Accordingly, the mechanism of the present invention provides a dedicated counter for controlling the second member for displaying the chronometered time unit, which notably enables widening of the field of possible applications for chronograph movements with two members for displaying the same unit of a chronometered time.

It may be possible to operate on the mobile carrying the first display member, notably to stop it or to release it, as in the split-second mechanism, but it furthermore becomes possible to operate on the second counter. Because of this, the latter may exhibit a movement different from that of the first counter, whilst being driven with the same angular speed as the latter when it is driven, so as to indicate a chronometered value in the same unit as that of the display member of the chronograph, i.e. the additional display member here.

For example, there may be provision for two hands to start moving at the same time, but for a first hand to be stopped on demand and then start to move again, also on demand, without catching up with the second hand, as is the case in split-time mechanisms. One possible application of such a mechanism would consist in measuring the duration of a hike, for example. The additional or chronograph hand would enable measurement of the total value of the seconds of the hike, while the first hand could be stopped at the beginning of each pause and then restarted at the end of each pause, to effect the measurement of the total actual walking time during the hike.

The mechanism may advantageously include a device for connecting the second mobile to the second counter and a member for locking the second mobile, both being arranged in such a way that the second mobile may be driven by the second counter or stopped while the second counter is driven in response to predefined actions of a user.

It will be noted that in this case the kinematic relationship between the second mobile and the second counter may preferably be similar to that between the conventional split-second mobile and the chronograph counter.

Moreover, there may be provision for the mechanism to include a clutch device arranged so as to enable or not driving of the second counter by the first counter in response to predefined actions of the user.

In a preferred embodiment, the first and second counters and the additional mobile may be coaxial, the clutch device comprising a vertical clutch associated with a clutch release member. Such a vertical clutch may be arranged coaxially with the first and second counters or alternatively be disposed laterally with respect to the first and second counters to limit the overall size of the mechanism in the axial direction. In this case, it may be associated with two wheels, disposed on respective opposite sides of the clutch, and preferably having respective permanent kinematic connections with the first or second counters.

An additional object of the present invention aims to propose such a chronograph mechanism notably arranged so as to drive two members for displaying the same unit of a chronometered time, preferably the second, in such a way that a first display member indicates the total measured value while the second display member enables display of partial times. For example, when timing a race comprising a plurality of laps of the same course, a first display member will enable measurement of the seconds corresponding to the total duration of the race while a second display member will enable measurement of the seconds corresponding to each race lap.

To achieve this object, there may be provision for the second counter to carry a resetting-to-zero cam associated with a resetting member movable between a high position, called the rest position, and a low position bearing against the so-called resetting-to-zero cam, the resetting-to-zero member being arranged so as to reset the second counter to zero in response to a predefined action of the user.

The clutch device and the resetting-to-zero member may advantageously be arranged so as to act in a substantially simultaneous manner to interrupt the driving of the second counter and to reset it to zero, respectively. The resetting-to-zero member may preferably include a stop for driving the clutch release member when it is actuated itself, notably to facilitate their synchronization.

To enable measurement of the next partial time, it may be preferable for the mechanism to include a control comprising a retractable actuating member arranged to actuate the resetting-to-zero member and to reset the second counter to zero in response to a predefined action of the user, and to be retracted and to release the resetting-to-zero member on resetting to zero of the second counter to enable the return of said resetting-to-zero member to the high position as a result of the effect of the action of spring means.

Thanks to these additional features, the second counter may be able to start the measurement of the next partial time as soon as it has been reset to zero.

The mechanism may preferably further include a control member arranged so as to control the state of the locking member of the second mobile, to lock the latter or not, the control acting on the resetting-to-zero member being arranged so as to act at least indirectly on this control member and to lock the second mobile on the resetting-to-zero of the second counter. It may thus be possible to read off the value of a partial time while the second counter is reset to zero and starts to count the next partial time.

The mechanism may advantageously further include an additional control arranged so as to act on said control member in response to a predefined action of the user in order to release the second mobile.

Thanks to this latter feature, the second mobile may be released to enable the first display member to catch up with the value measured by the second counter, since the reading off of the preceding partial time; the first display member therefore displays the value of the new partial time being measured.

The present invention also concerns a clockwork movement and a timepiece including a mechanism of the type that has just been described.

### BRIEF DESCRIPTION OF THE DRAWINGS

Other features and advantages of the invention will become more clearly apparent on reading the following detailed description given with reference to the appended drawings provided by way of nonlimiting example and in which:

FIG. 1 represents a partial diagrammatic top view of a clockwork movement including a chronograph mechanism of a preferred embodiment of the present invention, the latter movement being seen on its bridges side;

FIG. 2 represents a diagrammatic perspective view of the clockwork movement from FIG. 1, and

FIG. 3 represents a partial diagrammatic top view of the clockwork movement from FIG. 1, from its bridges side, showing constructional details of the mechanism of a preferred embodiment of the present invention,

### DETAILED DESCRIPTION

The following description aims to describe one particular embodiment of the present invention, to be more precise a mechanism intended to drive two members for displaying a time unit. However, the present invention also concerns a mechanism intended to drive only one display member.

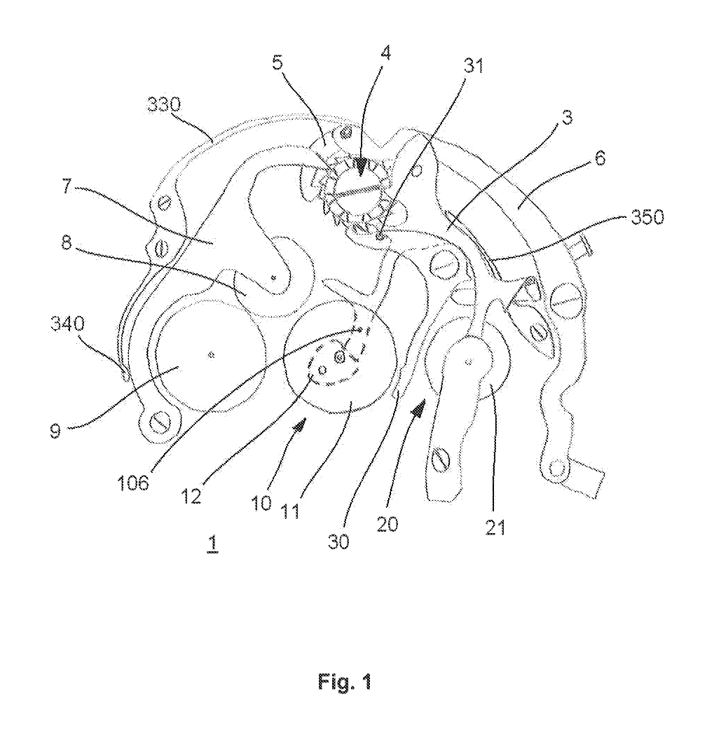

FIG. 1 represents a partial diagrammatic top view of a clockwork movement including a chronograph mechanism of a preferred embodiment of the present invention, the latter movement being seen from its bridges side. To be more precise, FIG. 1 shows, in simplified form, the principal elements of the chronograph mechanism for driving a conventional display member, namely a chronograph seconds hand (not visible in FIG. 1).

It is obvious that this movement is represented by way of nonlimiting illustration and that a person skilled in the art could, without departing from the scope of the invention, adapt the subject matter of the present invention to a chronograph mechanism of different construction.

This movement 1 includes framework elements including a plate (not visible), on which are mounted mobiles, levers and other clockwork components, of which only those related to the chronograph mechanism are shown and will be described in detail in the present disclosure.

The chronograph mechanism includes a chronograph counter 10 and a minutes counter 20.

Each of these counters comprises a mobile (the wheel 11, 21 whereof is visible) intended to be driven in relation with a timebase (that of the finishing gear train or a timebase specific to the chronograph) and is arranged so as to drive in rotation members for displaying measured times (not shown).

Each counter also includes a heart-shaped cam, only the cam 12 of the seconds counter being represented here, as if by transparency, each cam being constrained to rotate with the corresponding display member and intended to cooperate with an appropriate surface of a resetting-to-zero member 3.

The chronograph mechanism shown here by way of nonlimiting example is of the type with a column wheel 4. The latter wheel may be driven to rotate on itself by a hook 5 rigidly connected to a control 6, movements whereof may be commanded in the conventional way by a push-piece (not shown).

Each time the push-piece is pressed, the column wheel 4 rotates by one step, causing the chronograph function to go from a stopped state to an active state and vice versa. To this end, the alternating solid parts (columns) and gaps operate on different levers to activate or deactivate functions relating to the measurement of time intervals.

The column wheel notably cooperates with a clutch lever 7, carrying a clutch idler wheel 8 and mounted on the plate so as to pivot between a resting first position and a driving second position. Here the clutch lever is arranged so as to drive the chronograph gear train from a finishing gear train (not shown) via a seconds wheel 9 and the chronograph wheel 11 when the latter wheel meshes with the clutch idler wheel 8.

The minutes counter 20 may be driven from the seconds counter in the conventional manner.

The column wheel 4 also cooperates with a locking member 30, the function whereof is typically to hold the chronograph wheel 11 in a fixed angular position when the measurement of a time is interrupted. The locking member carries a finger 31 intended to be actuated by the resetting-to-zero member 3 when it descends on the cams in order to raise the locking member 30 and enable rotation of the wheel 11.

Moreover, the column wheel 4 is arranged so as to cooperate with the resetting-to-zero member 3, in a known manner, in order to force it to return to its high position and to release the seconds counter 10 and the minutes counter 20 when the measurement of a time is activated.

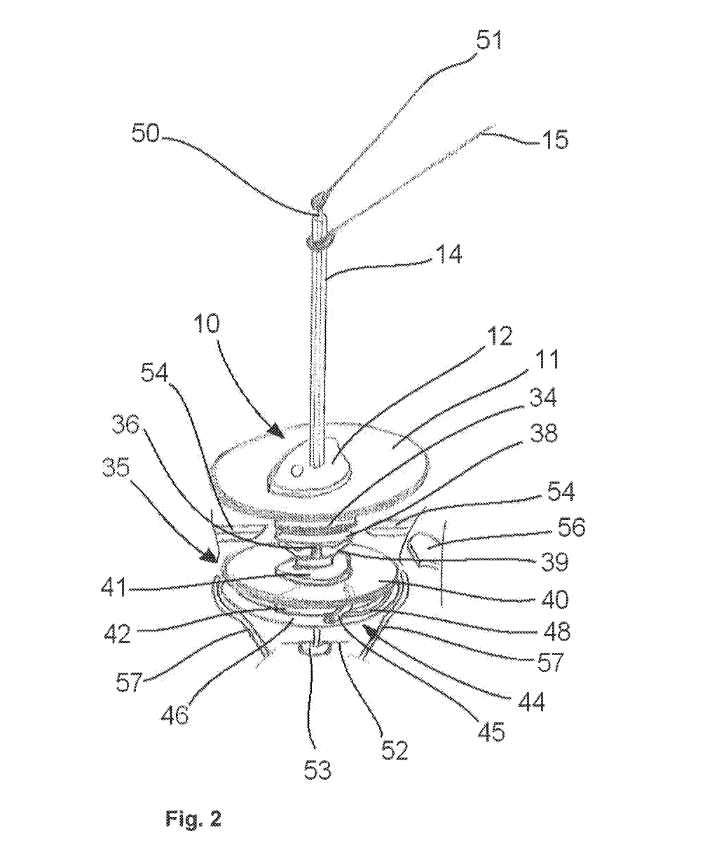

It will be noted that the heart-shaped cam 12 is disposed on the dial side relative to the seconds wheel 11 for reasons relating to overall size that will emerge notably from the detailed description of FIG. 2.

Various springs 330, 340 and 350 have moreover been represented in a nonlimiting way, operating respectively on the hook 5, the clutch lever 7 and the locking member 30 to define default positions thereof, in a known manner.

In a similar way, the resetting-to-zero hammers may be retained in their high position by a pin defining a detent and released by the user operating an external control member,

FIG. 2 shows part of the clockwork movement from FIG. 1 in a diagrammatic perspective view in which it is more particularly possible to see the components of a preferred embodiment of the present invention that complement the chronograph mechanism that has just been described hereinabove.

It is seen in FIG. 2 that the seconds mobile 10 includes a hollow shaft 14 intended to carry a member for displaying chronometered seconds, represented here in the form of a hand 15.

At its opposite end the shaft 14 carries a first plate 34 of a vertical clutch device, the first plate being constrained to rotate with the chronograph wheel 11.

The chronograph mechanism of the present invention comprises a second chronometered seconds counter 35, here arranged coaxially with the first counter. The second counter includes a shaft 36 preferably disposed outside the hollow shaft 14.

The shaft 36 carries a second plate 38 of the vertical clutch device as well as a spring 39 arranged so as to exert on the second plate 38 a force tending to hold it pressed against the first plate 34. The second plate 38 is constrained to rotate with the shaft 36 but may be moved in translation along the shaft over a predefined stroke. To this end, there may be provision for the shaft to have a non-circular section, for example a square section, in its portion associated with the stroke of the second plate, the second plate having an opening of complementary shape.

Moreover, the second counter includes an additional seconds wheel 40 carrying a first heart-shaped cam 41, on the dial side, and a second heart-shaped cam 42, on the bridges side (partially visible as if by transparency).

The second cam 42 is part of a connecting device intended to drive an additional mobile 44 for displaying chronometered seconds from the second counter. This connecting device is similar to that enabling a conventional split-second hand to be driven from the seconds counter. It includes a lever 45 pivotably mounted on a wheel 46 of the mobile 44 and the free end of which is held pressed against the periphery of the cam 42 by the action of a spring 48 also carried by the wheel 46.

Accordingly, by default, the wheel 46 is driven in synchronism with the second counter 35 by virtue of the action of the connecting device.

The additional mobile 44 also includes a shaft 50 arranged at least partially inside the hollow shaft 14 so as to have a free end situated outside the latter, on the dial side, with the aim of carrying thereon another hand 51 for displaying chronometered seconds.

The constructional details relating to the mounting of these mobiles on the framework of the clockwork movement will not be touched on here, given that a person skilled in the art will encounter no particular difficulty in implementing them according to their own requirements. There may nevertheless be provision for the framework notably to include a bridge 52 carrying a bearing 53 for the shaft 50 of the additional mobile.

Various controls have also been shown diagrammatically in FIG. 2, these controls being adapted to operate on the states of the second counter 35 and the additional mobile 44.

In particular, the ends of a conventional clamp 54 are shown facing the vertical clutch device. These ends are preferably beveled to facilitate separation of the two plates 34, 38 on disengagement of the clutch.

Moreover, an additional resetting-to-zero member 56 is provided facing the first cam 41 of the second counter 35 with the aim of enabling resetting to zero of said counter.

Moreover, a locking member taking the form of a clamp 57 is arranged facing the additional mobile 44 in such a way as to enable locking of its wheel 46 when necessary.

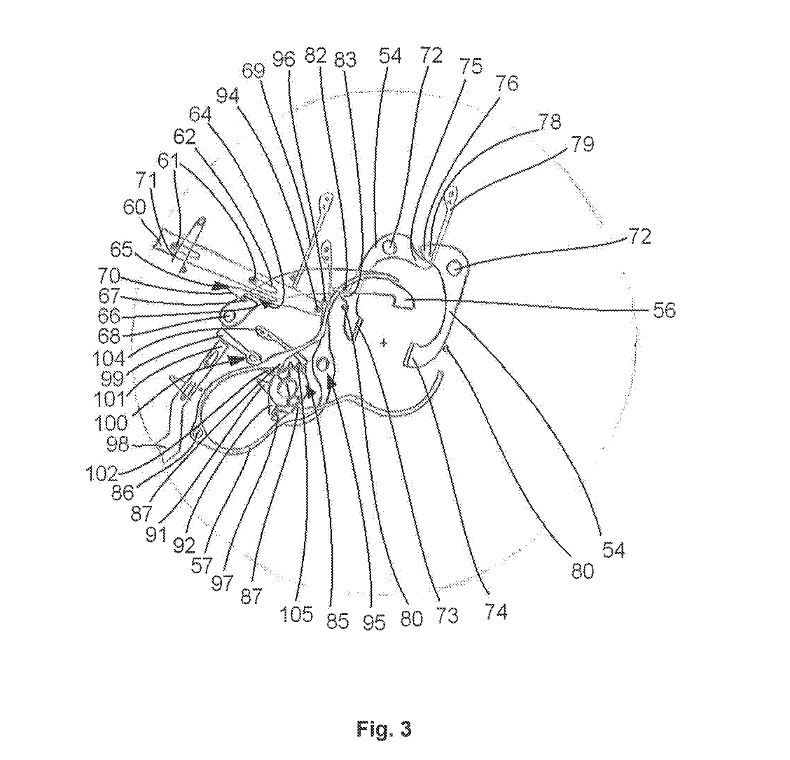

FIG. 3, which is a partial diagrammatic top view of the clockwork movement from FIG. 1 from its bridges side, shows better how the above controls operate and/or interact.

Before explaining the operation of the mechanism of the present preferred embodiment of the invention, it should be pointed out that the aim sought after here is to propose a chronograph mechanism adapted to drive a first chronograph hand 15, i.e, to display chronometered seconds. Accordingly, a first displayed value may for example correspond to the total duration of a race. There is furthermore provision for this chronograph mechanism also to enable driving of a second hand 51 for displaying chronometered seconds, in relation to the measurement of a partial time, the starting point whereof does not necessarily coincide with the start of the race. Accordingly, in the case of a race with a plurality of laps, for example, the second display hand 51 enables the seconds associated with each lap to be displayed.

To achieve this object, there is provision for the mechanism of the invention to be operated from first and second additional external control members, preferably of push-piece type (not shown), the first for stopping the second chronometered seconds hand 51, while the chronograph is operating, and the second for releasing it and starting the measurement of a new partial time.

To this end, the mechanism includes a first partial time control 60, arranged so as to operate on the resetting-to-zero hammer 56 intended to reset to zero the second counter 35. In the present preferred embodiment of the invention, by way of nonlimiting illustration, the first control is mobile in translation, being guided by the cooperation of two pins 61 carried by a framework element of the clockwork movement with two longitudinal slots 62 formed in the body of the first control. Of course, without departing from the scope of the invention, a person skilled in the art could adapt the nature of the guide means for the first control as a function of their requirements.

To enable restarting of the second counter 35 immediately after it is reset to zero in order to start the measurement of the next partial time, it is necessary for the second counter 35 and therefore the resetting-to-zero hammer 56 to be released as soon as the second counter is reset to zero.

To this end, the first control 60 includes a flexible finger 64, the free end 65 whereof has a first surface 66 oriented with a steep slope relative to the direction of movement of the first control 60 and intended to cooperate with a pin 67 rigidly connected to the hammer 56. Accordingly, when the first control is actuated toward the interior of the clockwork movement, the first surface 66 drives the pin 67, lowering the hammer 56 against the first cam 41 of the second counter 35 to reset it to zero by rotation about a post 68 fixed relative to the framework of the clockwork movement.

The stroke of the first control 60 is adjusted in such a way that said control has not reached the end of its stroke when the second counter is reset to zero. With the user holding down the corresponding external control member, the first control 60 then continues its stroke, forcing the finger 64 to be deformed to the point at which it is retracted and releases the pin 67, and therefore the hammer 56, which can then return to its high position and release the second counter 35, as a result of the effect of the action of a spring 69, shown diagrammatically here.

The free end 65 of the finger 64 has a second surface 70 adjacent the first surface 66 but of shallow slope. Accordingly, when the first control 60 is released by the user, it rises into its high position (as shown in FIG. 3) as a result of the effect of the action of a spring 71, shown diagrammatically here. In so doing, the free end 65 comes into contact with the pin 67 of the hammer 56 via its second surface 70, the orientation whereof favors the deformation of the flexible finger 64, which is retracted again to enable the first control 60 to rise into its rest position.

Moreover, FIG. 3 shows diagrammatically the clutch clamp 54 operating on the vertical clutch device providing the kinematic connection between the first and second counters.

Each half-clamp is pivotably mounted on a post 72 fixed relative to the framework of the clockwork movement and includes first ends 73, 74 and second ends 75, 76, the first ends 73, 74 being intended to operate on the vertical clutch device. The second ends 75, 76 cooperate with each other for synchronized positioning of the two half-clamps. To be more precise, one of the half-clamps carries a pin 78 on which acts a spring 79 tending to cause it to turn in the clockwise rotation direction, i.e. to position it in its spread position or clutch engaged position. The end 76 operates on the end 75 to cause the other half-clamp to turn in the anticlockwise rotation direction, i.e. also in the direction of its spread position. A post 80 rigidly connected to the framework of the clockwork movement defines a stop for each of the half-clamps in its spread position.

Accordingly, by default, the half-clamps are in their spread position, the clutch device being engaged. In this configuration, the second counter 35 is driven synchronously with the chronograph counter when the chronograph function is active.

Nevertheless, on resetting of the second counter 35 to zero, it is preferable to disengage it from the chronograph counter to prevent premature wear of the clutch device. Accordingly, the hammer 56 includes a pin 82 arranged so as to cooperate with a finger 83 provided on one of the half-clamps to drive the latter when it is actuated. This half-clamp is driven in the direction of its clamped position, i.e. into a position in which the clutch device is disengaged. As it rotates, this half-clamp simultaneously drives the other half-clamp by virtue of the cooperation between the second ends 75 and 76, in such a way that the two half-clamps operate simultaneously on the clutch device to disengage the second counter from the chronograph counter.

In a similar manner, when the hammer 56 is released and resumes its high position, it releases the clamp 54, which resumes its spread position as a result of the effect of the action of the spring 79.

With the hammer 56 rising as soon as the second counter 35 is reset to zero, said counter is then immediately driven in synchronism with the chronograph counter, to start the measurement of the next partial time.

Moreover, to enable reading of the partial time, it is necessary for the first control 60 also to operate on a locking member of the additional mobile 44 to immobilize the additional hand 51.

This locking member comprises the clamp 57 mentioned with reference to FIG. 2. The clamp 57 may be commanded by a column wheel type control member 85 to assume two states, an open state and a closed state (the open state being shown in FIG. 3). In the preferred embodiment shown here by way of nonlimiting illustration, the clamp 57 comprises two half-clamps formed in one piece and secured to the framework of the clockwork movement by a screw 86. Each of the half-clamps includes, in its median region, a nose 87 arranged so as to cooperate with the columns of the column wheel 85.

The column wheel 85 is mounted to rotate on the framework between first and second angular positions. In a first position (shown in FIG. 3) a column is disposed facing each nose 87 so as to open the clamp 57 and free the additional mobile 44. In the second position, the columns are no longer disposed facing the noses 87 and the clamp 57 may assume its closed state to immobilize the additional mobile 44.

The column wheel 85 shown here includes two sawteeth 91 and 92, each of which is adapted to enable driving of the column wheel in rotation in a specific rotation direction.

Accordingly, the first control 60 includes a pin 94 arranged so as to cooperate with a lever 95 pivotably mounted on the framework of the clockwork movement at a first end 96, while the lever includes a second end 97 intended to cooperate with the tooth 91 of the column wheel to cause said wheel to turn in the anticlockwise rotation direction.

Consequently, when the first control 60 is actuated, the second counter is reset to zero and then immediately released to start a new measurement of a partial time, while the additional mobile 44 and thus the additional hand 51 are immobilized.

The mechanism of the present invention includes a second control 98 intended to be actuated by a second external control member and arranged so as to drive rotation of the column wheel 85 in the reverse direction to that which has just been described. By way of nonlimiting illustration, the second control is mounted on the framework so as to move in translation in a similar manner to the first control 60. It is arranged so as to operate on a first end 99 of an additional lever 100 via its end 101 situated toward the center of the clockwork movement. The lever has a second end 102 arranged so as to cooperate with the tooth 92 of the column wheel 85 and to cause said wheel to turn in the clockwise rotation direction. However, such action is possible only when the clamp 57 is in its closed state, the tooth 92 being in this case positioned on the stroke of the second end 102 of the lever 100, which is not the case when the clamp 57 is open.

Accordingly, when the clamp 57 is open, in response to action on the second control 98, the additional mobile 44 is released and is able to catch up with the angular position of the second counter 35, via the action of the lever 45 on the second cam 42 of the second counter. For example, if the additional hand 51 is immobilized for ten seconds, following action on the first control 60 and before the second control 98 is actuated to release it, it moves virtually immediately to its position corresponding to a measurement of ten seconds when it is released.

A conventional jumper 104, cooperating with appropriate teeth 105, is preferably provided to ensure correct angular positioning of the column wheel 85.

Alternatively, there may be provision for the column wheel 85 to be of conventional type, notably for it to comprise a conventional ratchet, with an even number of regularly distributed columns. In this case, the first and second controls must be arranged so as to cause said column wheel to turn in one and the same direction so as to pass alternately from a closed state to an open state of the clamp 57 and vice versa. It will then be noted that the second control 98, if it is used on its own, i.e. without resetting the second counter to zero beforehand, fulfills a function similar to that of a conventional split-second control. It enables the additional hand 51 to be immobilized so as to indicate the value of an intermediate time and then to be released so that it catches up with the main hand 15, via successive actions. It will also be noted that, in such a configuration, exclusive use of the first control 60 enables measurement of the seconds of non-consecutive chronometered partial times. A first action on the first control after starting the chronograph leads to resetting-to-zero of the second counter 35 and immobilization of the additional hand 51 to indicate the value of a first partial time. A second action on the first control starting from this state leads to resetting-to-zero of the second counter and starting of the measurement of a new partial time, this time with simultaneous releasing of the additional hand 51, which then restarts from zero.

A person skilled in the art may choose between the column wheel versions described above, or even a different control member, without departing from the scope of the present invention.

It should be noted that the structure of the column wheel 85 as shown offers a higher level of security against user manipulation errors than the embodiment described, notably because the additional hand 51 can be released only by action on the second control 98.

It emerges from the foregoing description that the driving of the additional hand 51 is conditioned by the previous driving of the first hand 15, i.e. by the operation of the basic chronograph mechanism. If the measurement of a time is stopped, the second counter 35 is also immobilized because of the nature of its kinematic connection with the chronograph counter.

Nevertheless, at the time of the resetting-to-zero of the chronograph counter by means of the hammers 3, the second counter may find itself in a relative position such that the two hands 15 and 51 are not superposed. It is consequently necessary to provide for resetting of the chronograph counter to zero simultaneously to command resetting-to-zero of the second counter by means of the heart-shaped cam 41. To this end there may for example be provision for the resetting member 3 of the chronograph to be provided with a pin 106 (shown diagrammatically in FIG. 1) arranged so as to exert an appropriate force on the hammer 56 when the user commands resetting-to-zero of the chronograph. The hammer 56 is then held in its low position for as long as the hammers 3 remain lowered.

As previously mentioned, the mechanism of the present invention may be associated with a chronograph mechanism of any type, i.e. shuttle or column wheel type, with fly-back operation or not.

It will be noted that, in an alternative preferred embodiment, the chronograph mechanism that has just been described may be employed to drive a single member for displaying a time unit of a measured time, namely the hand 51 rigidly connected to the mobile 44 here. In this case, the first counter may be configured differently, i.e. with no shaft intended to carry the hand 15. The rest of the mechanism as described could thus remain unchanged. The single display member provided could then have two functions at the choice of the user, as a function of their requirements.

Accordingly, after standard starting of the chronograph function by the conventional push-piece, the user could choose between conventional time measurement, using only the conventional push-piece, and lap time measurement. To use this latter function, they would actuate the additional push-pieces in exactly the same manner as described above in the case of driving two display members. Consequently, a watch employing such a mechanism would differ from an ordinary chronograph only in that it includes one or two additional push-pieces.

The foregoing description aims to describe a particular embodiment by way of nonlimiting illustration and the invention is not limited to the employment of certain particular features which have just been described, for example the shapes specifically shown and described for the various levers, controls, and the control member. The clamp 57, for example, could be replaced by a simple brake with only one arm. There could also be provision for employing an isolator between the additional mobile and the second counter in a similar manner to what is known from split-second mechanisms. Similarly, the vertical clutch could alternatively be disposed laterally with respect to the first and second counters to limit the overall size of the mechanism in the axial direction. In this case, it could be associated with two wheels, disposed on respective opposite sides of the clutch and preferably having respective permanent kinematic connections with the first and second counters.

A person skilled in the art will have no particular difficulty in adapting the content of the present disclosure to his own requirements and employing a chronograph mechanism with two counters for the same time unit of a chronometered time using only some of the features disclosed here, without departing from the scope of the present invention.

It is moreover possible to employ variant embodiments offering functions different from those described with reference to the figures, as disclosed above.

Putting the present teaching into practice may also be envisaged by applying it to a chronograph mechanism intended to drive two seconds hands and two minutes hands.

1. A chronograph mechanism for a clockwork movement intended to drive at least one first display member for displaying a time unit of a chronometered time, the mechanism including
a first counter of said time unit able to be driven from a mobile of the clockwork movement,
as well as a second mobile intended to carry said display member and arranged in such a way as to be able to be driven in synchronism with said first counter,
the chronograph mechanism further including a second counter of said time unit associated with said display member and able to be driven in synchronism with said first counter, said second counter being arranged in such a way that said second mobile is driven thereby, whilst being able to exhibit a relative movement in relation thereto, i.e. to be decoupled therefrom.

2. The mechanism of claim 1, further including a device for connecting said second mobile to said second counter and a locking member for locking said second mobile, both being arranged in such a way that said second mobile may be driven by said second counter or stopped, while said second counter is driven, in response to predefined actions of a user.

3. The mechanism of claim 2, further including a clutch device arranged so as to enable or not driving of said second counter by said first counter in response to predefined actions of the user.

4. The mechanism of claim 3, wherein said first and second counters and said second mobile are coaxial, said clutch device comprising a vertical clutch associated with a clutch release member.

5. The mechanism of claim 4, wherein said second counter carries a resetting-to-zero cam associated with a resetting-to-zero member mobile between a high position, called a rest position, and a low position bearing against said resetting-to-zero cam, said resetting-to-zero member being arranged so as to reset said second counter to zero in response to a predefined action of the user.

6. The mechanism of claim 5, wherein said clutch device and said resetting-to-zero member are arranged so as to act in a substantially simultaneous manner to interrupt the driving of said second counter and to reset it to zero, respectively.

7. The mechanism of claim 6, wherein said resetting member includes a stop for driving said clutch release member when it is actuated itself.

8. The mechanism of claim 7, further including a control comprising a retractable actuating finger arranged
to actuate said resetting-to-zero member and to reset said second counter to zero in response to a predefined action of the user, and
to be retracted and to release said resetting-to-zero member on resetting-to-zero of said second counter to enable the return of said resetting-to-zero member to the high position as a result of the effect of the action of spring means.

9. The mechanism according to claim 5, further including a control member arranged so as to control the state of said locking member of said second mobile, to lock the latter or not, said control being arranged so as to act at least indirectly on said control member and to lock said second mobile on resetting-to-zero of said second counter.

10. (canceled)

11. The mechanism according to claim 1, wherein said first counter is a seconds counter, the mechanism further including members arranged so as to command the starting, stopping and resetting-to-zero of said first counter in response to predefined actions of a user,

12. The mechanism of claim 1, wherein said first counter is associated with an additional display member.

13. The mechanism of claim 1, further including a clutch device arranged so as to enable or not driving of said second counter by said first counter in response to predefined actions of the user.

14. The mechanism of claim 13, wherein said first and second counters and said second mobile are coaxial, said clutch device comprising a vertical clutch associated with a clutch release member.

15. The mechanism of claim 14, wherein said second counter carries a resetting-to-zero cam associated with a resetting-to-zero member movable between a high position, called a rest position, and a low position bearing against said resetting-to-zero cam, said resetting-to-zero member being arranged so as to reset said second counter to zero in response to a predefined action of the user.

16. The mechanism of claim 15, wherein said clutch device and said resetting-to-zero member are arranged so as to act in a substantially simultaneous manner to interrupt the driving of said second counter and to reset it to zero, respectively.

17. The mechanism of claim 16, wherein said resetting member includes a stop for driving said clutch release member when it is actuated itself.

18. The mechanism of claim 2, wherein said first counter is a seconds counter, the mechanism further including members arranged so as to command the starting, stopping and resetting-to-zero of said first counter in response to predefined actions of a user.

19. The mechanism of claim 2, wherein said first counter is associated with an additional display member.

20. A clockwork movement comprising a chronograph mechanism according to claim 1.

21. A timepiece comprising a clockwork movement according to claim 20.
